(19) United States
(12) Patent Application Publication
(10) Pub. No.: US 2008/0114116 A1
(43) Pub. Date: May 15, 2008

(54) Method for synthesizing conjugated polymer by plasma polymerization

(75) Inventors: Arnold Chang-Mou Yang, Hsinchu City (TW); Chun-Chih Chang, Taichung City (TW); Yi-Hsin Chang, Keelung City (TW)

Correspondence Address: BIRCH STEWART KOLASCH & BIRCH, PO BOX 747, FALLS CHURCH, VA, 22040-0747, US

(73) Assignee: National Tsing Hua University

(21) Appl. No.: 11/907,492

(22) Filed: Oct. 12, 2007

(30) Foreign Application Priority Data
Nov. 14, 2006 (TW) 95142052

(51) Int. Cl. C08K 3/40; C08F 2/00; C08K 3/34

(52) U.S. Cl. 524/442; 526/62

(57) ABSTRACT

A method for synthesizing conjugated polymer by plasma polymerization, which comprises the steps of introducing at least one monomer at a high concentration into a vacuum chamber; and igniting plasma, wherein the monomer is shattered into preferable-size fragments and is activated, and the activated monomers polymerize or copolymerize with one another to form the conjugated polymer.

### BACKGROUND OF THE INVENTION

a) Field of the Invention

The invention relates to a method for synthesizing conjugated polymer and, more particularly, to a method for synthesizing conjugated polymer by plasma polymerization.

b) Description of the Related Art

Plasma polymerization refers to a polymerization reaction by way of free radicals generated from plasma activation, and hence it breaks the conventional reaction rules for chemical functional groups. Since no solvent is needed for the polymerization reaction, the probability of the contamination with respect to products during the polymerization process is greatly reduced. Moreover, because of the simpler process steps for the plasma polymerization than the conventional polymerization method, the production cost of the conventional polymer material is lowered effectively, and mass production thereof can be achieved easily with industrially economic benefits.

In conventional plasma polymerization process, monomers are vaporized outside of a chamber and then introduced by a carrier gas into plasma for the polymerization reaction. The polymer formed by polymerization can be deposited on a substrate and form a smooth polymer film. During the polymerization process, gaseous monomer molecules are subjected to the bombardment of high-speed charged particles in plasma and are shattered into molecular fragments with strong reactivity, before deposited on the substrate. However, the molecules are so heavily damaged due to the large amount of the high-speed charged particles that the polymer film deposited in this way would have great difference in the chemical structure between the film and the monomer. This would limit the applications of plasma polymerization.

In response to lowering the damage to chemical functional groups and structures in plasma polymerization, pulsed plasma was proposed for use in polymerization reaction. Although using pulsed plasma for polymerization does solve a small part of the problems on the damage of functional groups, it also slows the growth of the film, leading to a prolonged reaction period of plasma polymerization. That is a significant drawback for industrial production.

In conclusion, it is now a goal in effort to prevent monomer particles from being damaged during plasma polymerization while synthesizes polymer in a relatively shorter reaction period of time for depositing a polymer film.

### BRIEF SUMMARY OF THE INVENTION

In view of the aforementioned problems, an object of the invention is to provide a method for synthesizing conjugated polymer by plasma polymerization, which is capable of preventing monomer particles from being damaged in plasma polymerization process and at the same time, forming conjugated polymer by polymerization in a relatively shorter reaction period of time.

To achieve the object, a method for synthesizing conjugated polymer by plasma polymerization of the invention includes the steps of: introducing at least one monomer at a high concentration into a vacuum chamber; and igniting plasma, wherein the monomer is shattered into preferable-size fragments and is activated, and the activated monomers polymerize or copolymerize with one another to form the conjugated polymer. The monomer includes a conjugate structure and a functional group, and the functional group absorbs energy to break the bonding between the functional group and the monomer after the plasma is ignited.

According to the invention, the functional group of the monomer can effectively protect the conjugate structure of the monomer, which reduces the damage to the conjugate structure caused by plasma. Thus continuous wave plasma can be used to carry out plasma polymerization, which, in turn, shortens the reaction period of time and speeds up the deposition for conjugated polymer film.

### BRIEF DESCRIPTION OF THE DRAWINGS

FIG. 1A is a schematic diagram illustrating the synthesis of conjugated polymer by plasma polymerization according to a preferred embodiment of the invention.

FIG. 1B is a schematic diagram illustrating the synthesis of conjugated polymer by plasma polymerization according to another preferred embodiment of the invention.

FIG. 2 is a graph illustrating the analysis of the functional group of conjugated polymer particle made according to an embodiment of the invention, the analysis being performed with FTIR.

FIG. 3 is an absorption spectrum of the conjugated polymer particle made according to an embodiment of the invention.

FIG. 4 is a fluorescence spectrum of the conjugated polymer particle made according to an embodiment of the invention.

FIG. 5 is a fluorescence spectrum of the conjugated polymer film made according to an embodiment of the invention.

### DETAILED DESCRIPTION OF THE INVENTION

The method for synthesizing conjugated polymer by plasma polymerization according to preferred embodiments of the invention will be described in detail with reference to the drawings, in which like reference numerals denote like elements.

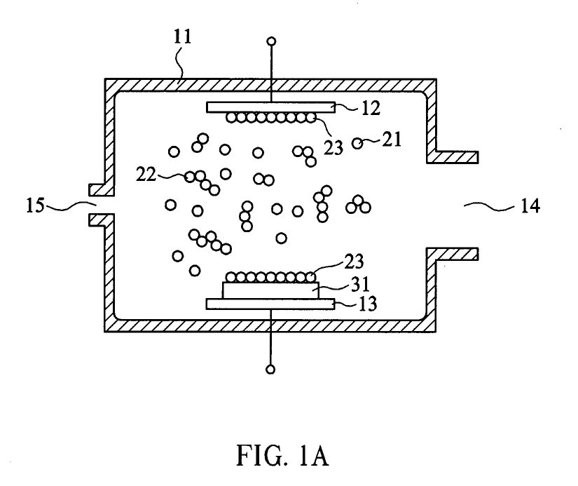

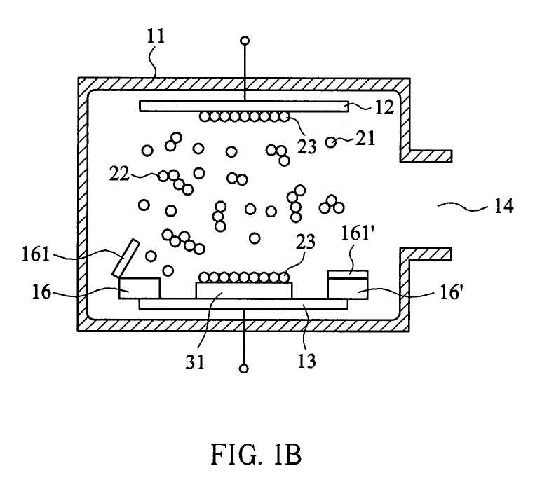

Referring to FIG. 1A, for a method for synthesizing conjugated polymer by plasma polymerization according to a preferred embodiment of the invention, the polymerization or copolymerization is carried out in a chamber 11. The chamber 11 includes a first electrode 12 and a second electrode 13 for generating plasma and it can be vacuumized by suction via a vacuum port 14. Besides, at least one monomer 21 used for plasma polymerization is introduced into the chamber 11 via an injection port 15. It is to be noted that the monomers 21 may be placed in the chamber 11 and be vaporized by heating directly, or as shown in FIG. 1B, a vessel 16 containing the monomers 21 may have at least a portion of its opening be placed in plasma environment so that the monomers 21 can be vaporized through plasma energy, or the monomers 21 may be vaporized by a combination of the two, then followed by the plasma polymerization. The vessel 16, through a shield 161, can control the entrance of the monomers 21 into the plasma environment. For example, the monomers 21 are prevented from entering the plasma environment if the vessel 16′ is closed by the shield 161′ as shown.

Next, the method for synthesizing conjugated polymer by plasma polymerization is described. Firstly, the at least one monomer 21 is introduced into the vacuum chamber 11 at a high concentration, wherein the monomers can be solid, liquid, or solid-liquid immiscible, and each of the monomers 21 includes a functional group. Secondly, plasma is ignited to carry out plasma polymerization or copolymerization. When the monomers 21 are subjected to the bombardment of high-speed particles in the plasma, their functional groups absorb the energy of the high-speed particles more easily, and the bonding between the functional group and the monomer 21 is broken, which in turn activates the monomers 21. The activated monomers 21 polymerize with one another at where the bonding is broken to form oligomers 22 and further to form conjugated polymer 23. The vacuum level in the chamber 11 is 0.1 to 1 torr and the power of the plasma is 1 to 400 W.

By controlling different process parameters, conjugated polymer powder can be synthesized or a thin film can be deposited or produced. Therefore, a substrate 31 may be placed in the chamber 11 and the conjugated polymer 23 formed by plasma polymerization can be deposited or produced on the surface of the substrate 31 to form a conjugated polymer thin film. The substrate 31 can be, for example, glass, conductive glass like indium tin oxide glass (ITO), a silicon chip, a polymer substrate, a polymer film, or a composite material.

The monomers 21 used in the plasma polymerization each has a conjugate structure, and the damage to the conjugate structure of the monomer 21 by the high-speed particles in the plasma is reduced by the functional group of the monomer 21. In other words, the functional group of the monomer 21 serves to protect the conjugate structure of the monomer 21. The monomer 21 can be an aromatic organic compound, and preferably an organic compound with multiple benzene rings.

In one embodiment, the monomers 21 are vaporized, and the vaporized monomers 21 can be introduced into the chamber 11 directly with or without using a carrier gas. It is more preferable for the monomers 21 to be introduced into the chamber 11 solo because of the higher concentration of the monomers in the chamber 11, which, in turn, shortens the reaction period of time. If a carrier gas is used, a compound having a conjugate structure or benzene ring is preferred. Through plasma polymerization, the vaporized monomers 21 are activated and polymerize into polymers 23 before depositing on the surface of the substrate 31, forming a conjugated polymer thin film.

In another embodiment, liquid-phase monomers are placed directly into plasma environment for synthesizing polymers by condensed-phase plasma polymerization. For example, liquid-phase monomers 21 are introduced into the chamber 11 at a high concentration and shaped into a flat liquid film on the substrate 31, the surface of which is pretreated by quick plasma surface treatment. Plasma polymerization is then carried out to produce a conjugated polymer thin film on the substrate 31.

In yet another embodiment, after conjugated polymers are synthesized, plasma in the chamber 11 is removed from the chamber 11. This is so that post-polymerization processes can be carried out in the chamber 11 directly without relocating the conjugated polymers 23 or the substrate 31 to another processing chamber, reducing probability of contamination to the product.

Since plasma polymerization reaction occurs randomly, the conjugated polymers thus formed have cross-linked structure which can prevent the crystallization of the conjugated polymers and increase the glass transition temperature Tg thereof. Accordingly, such conjugated polymers have better chemical and thermal stability. Moreover, since polymerization of monomers with conjugate structure can effectively increase the length of conjugate structure, the conjugated polymer therefore can be utilized as an organic light-emitting material with a light-emitting wavelength of 400 to 800 nm.

An example is used to illustrate the method for synthesizing conjugated polymer by plasma polymerization of the invention. In the example, liquid 1-naphthaldehyde is used as monomers, wherein the conjugate structure of the monomer is protected by the fact that the aldehyde group therein is easily subject to damage first by plasma. Substituting the aldehyde with ethyl, the effect of protecting conjugate structure of the monomer remains. First, the 1-naphthaldehyde is heated at a temperature of 40° C. in an insulating container within the chamber 11. Next, in this example, vacuumize the chamber 11 to the extent of 0.2 torr. Last, plasma is started/ignited to carry out polymerization. The power and frequency of plasma have great influence on plasma polymerization. In this example, the plasma is radio frequency plasma with a frequency of 13.56 MHz and power of 30 W or 150 W. After a reaction period of 30 minutes, polymer particles formed by plasma polymerization can be obtained. A conjugated polymer thin film can be obtained on the surface of ITO glass or silicon substrate by adjusting process parameters like the plasma power to 15 W, 30 W, 100 W, 150 W, 200 W, and 250 W, and the reaction period of time to 3 minutes.

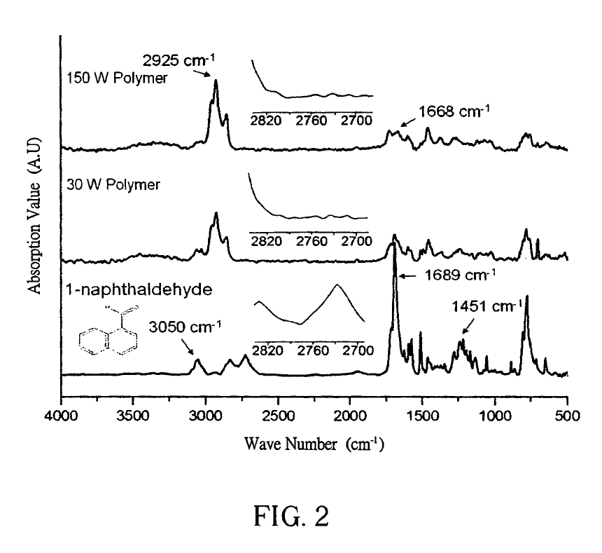

Referring to FIG. 2 to FIG. 4, characteristics of the conjugated polymer prepared according to the example is described. Fourier transform infrared spectroscopy (FTIR) is used to analyze the chemical structure of the functional group of the prepared conjugated polymer, and the result is shown in FIG. 2. It is observed from FIG. 2 that the aldehyde of the conjugated polymer obtained by plasma polymerization at the plasma power of 30 W or 150 W all disappears due to the effect of plasma polymerization reaction (2727 cm⁻¹, 2832 cm⁻¹), while the conjugate structures thereof, like benzene ring (600-900 cm⁻¹) and unsaturated hydrocarbon link (3050 cm⁻¹), are effectively kept.

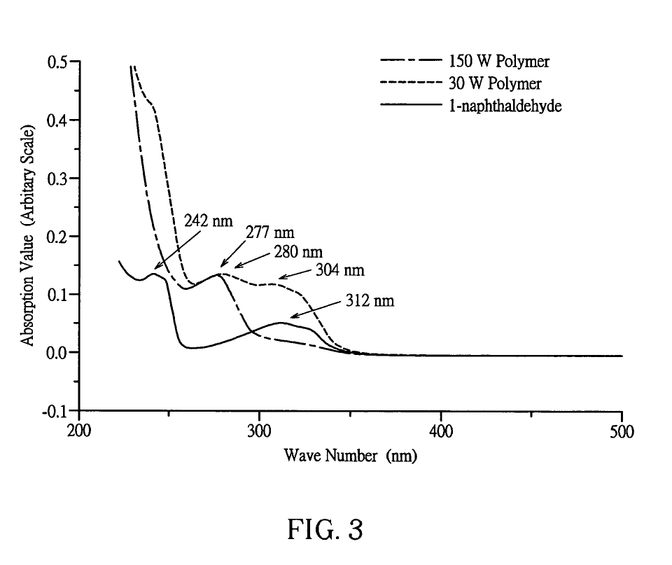

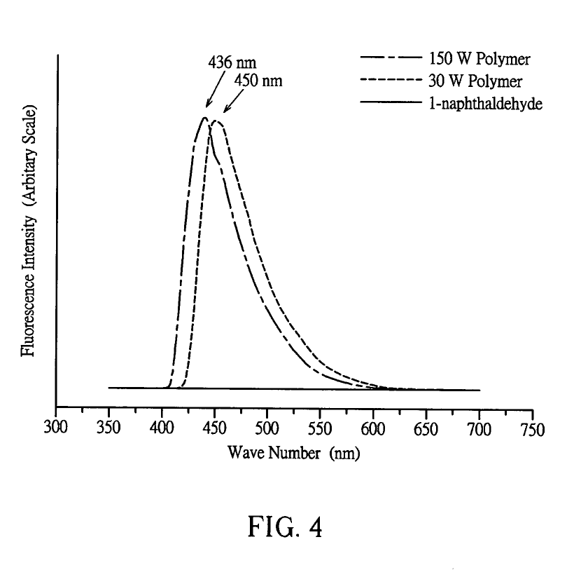

The absorption spectrum of the plasma-polymerized conjugated polymer is illustrated in FIG. 3. Comparing π→π* absorption peak of the 1-naphthaldehyde with that of the plasma-polymerized conjugated polymer, it is observed that the absorption peak shifts from the original 242-250 nm to 277 nm. Concluding from this, the conjugate structure of the conjugated polymer formed with 1-naphthaldehyde by plasma polymerization can be effectively elongated in the length. On the other hand, FIG. 4 illustrates the fluorescence spectrum of the plasma-polymerized polymer. It is observed from FIG. 4 that the monomer, 1-naphtaldehyde, is not characterized by luminescence. However, after plasma polymerization, since the length of the conjugate structure in the plasma-polymerized conjugated polymer is effectively elongated, the conjugated polymer displays good fluorescence quality. The light-emitting spectrum of the plasma-polymerized conjugated polymer falls within the range of blue light, and the quantum efficiency can be up to 35%.

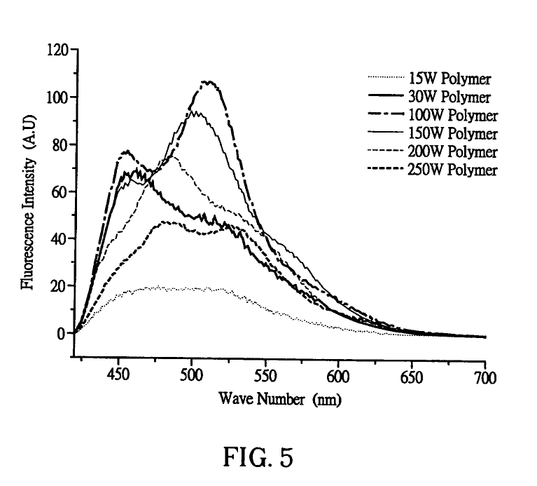

The fluorescence spectrum of a plasma-polymerized conjugated polymer film is shown in FIG. 5. It is observed that the desired fluorescence characteristic can be obtained by adjusting the different process parameters effectively. For example, by controlling the process parameters, selecting different monomers, or doping with other monomers, like providing hole material, the plasma-polymerized conjugated polymer film can have a luminescent spectrum with a suitable red/green/blue ratio and can directly emit visible white light. Thus a luminescent film that emits white light is made by one single step, which is much simpler than the conventional method where respective compounds emitting red/green/blue light are prepared, followed by being mixed in a ratio for emitting white light.

According to the method for synthesizing conjugated polymer by plasma polymerization of the invention, the functional group of the monomer can effectively protect the conjugate structure of the monomer from the damage of the plasma. It is not necessary to reduce the damage of the plasma to the conjugate structure by using the pulsed plasma. In fact, carrying out the plasma polymerization with the continuous wave plasma decreases the reaction period of time and increases the rate of the deposition of the conjugated polymer film. In addition, the small molecule functional group does not participate in the polymerization reaction, and therefore will not contaminate the plasma-polymerized conjugated polymer. Moreover, the monomers having functional groups have a lower melting point, which is beneficial for different types of treatments in the process.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretations so as to encompass all such modifications and similar arrangements.

What is claimed is:

1. A method for synthesizing conjugated polymer by plasma polymerization, comprising:
introducing at least one monomer at a high concentration into a vacuum chamber; and
igniting plasma, wherein the monomer is shattered into preferable-size fragments and is activated, and the activated monomers polymerize or copolymerize with one another to form the conjugated polymer.

2. The method for synthesizing conjugated polymer by plasma polymerization, further comprising:
vaporizing the monomer.

3. The method for synthesizing conjugated polymer by plasma polymerization as described in claim 2, wherein the monomer is directly placed in the chamber for thermal vaporization, plasma vaporization, or a combination thereof.

4. The method for synthesizing conjugated polymer by plasma polymerization as described in claim 2, wherein the monomer is vaporized outside of the chamber before being introduced thereinto.

5. The method for synthesizing conjugated polymer by plasma polymerization as described in claim 2, wherein the monomer is vaporized outside of the chamber before being introduced thereinto by a carrier gas.

6. The method for synthesizing conjugated polymer by plasma polymerization as described in claim 5, wherein the carrier gas is a compound having a conjugate structure or benzene ring.

7. The method for synthesizing conjugated polymer by plasma polymerization as described in claim 1, wherein the chamber includes a substrate placed therein, and the conjugated polymer, after being formed, is deposited on the substrate to form a conjugated polymer film.

8. The method for synthesizing conjugated polymer by plasma polymerization as described in claim 7, wherein the substrate is glass, conductive glass, a silicon chip, a polymer substrate, a polymer film, or a composite material.

9. The method for synthesizing conjugated polymer by plasma polymerization as described in claim 7, wherein the conjugated polymer is an organic light-emitting material.

10. The method for synthesizing conjugated polymer by plasma polymerization as described in claim 9, wherein the organic light-emitting material emits light in the wavelength range of 400 to 800 nm.

11. The method for synthesizing conjugated polymer by plasma polymerization as described in claim 1, wherein the monomer has a conjugate structure.

12. The method for synthesizing conjugated polymer by plasma polymerization as described in claim 1, wherein the monomer comprises an aromatic organic compound.

13. The method for synthesizing conjugated polymer by plasma polymerization as described in claim 1, wherein the monomer comprises an organic compound with multiple benzene rings.

14. The method for synthesizing conjugated polymer by plasma polymerization as described in claim 1, wherein the monomer comprises 1-naphthaldehyde.

15. The method for synthesizing conjugated polymer by plasma polymerization as described in claim 1, wherein the monomer includes a functional group, and the functional group absorbs energy to break the bonding between the monomer and the functional group after plasma is ignited.

16. The method for synthesizing conjugated polymer by plasma polymerization as described in claim 15, wherein the functional group is aldehyde.

17. The method for synthesizing conjugated polymer by plasma polymerization as described in claim 15, wherein the functional group is ethyl.

18. The method for synthesizing conjugated polymer by plasma polymerization as described in claim 1, wherein the monomer is solid, liquid, or solid-liquid immiscible.

19. The method for synthesizing conjugated polymer by plasma polymerization as described in claim 1, wherein the conjugated polymer has a cross-linked structure.

20. The method for synthesizing conjugated polymer by plasma polymerization as described in claim 1, further comprising: removing plasma from the vacuum chamber for post-polymerization.
